(19) United States
(12) Patent Application Publication
(10) Pub. No.: US 2017/0238196 A1
(43) Pub. Date: Aug. 17, 2017

(54) COMMUNICATION DEVICE AND COMMUNICATION SYSTEM

(71) Applicant: Mitsubishi Electric Corporation, Tokyo (JP)

(72) Inventors: Masahiro NAKATSUKASA, Tokyo (JP); Yasuaki TAKIMOTO, Tokyo (JP); Hideki FUKUHARA, Tokyo (JP); Takehisa MIZUGUCHI, Tokyo (JP)

(73) Assignee: Mitsubishi Electric Corporation, Tokyo (JP)

(21) Appl. No.: 15/502,320

(22) PCT Filed: Oct. 10, 2014
(86) PCT No.: PCT/JP2014/077227

§ 371 Date: Feb. 7, 2017

(51) Int. Cl. H04W 24/02

(52) U.S. Cl. CPC H04W 24/02; H04W 88/04

(57) ABSTRACT

The network connection information about a mobile communication terminal 30 is notified from a tablet terminal 20 joining a network B provided by the mobile communication terminal 30 to an HU 10 via short-range wireless communications. The dual-mode HU 10 uses the network connection information, notified from the tablet terminal 20, to configure anew a network C which the HU 10, the tablet terminal 20 and the mobile communication terminal 30 join.

### TECHNICAL FIELD

The present invention relates to a dual-mode communication device that is operable in both master and slave modes, and a communication system using such a communication device.

### BACKGROUND ART

A head unit (hereafter referred to as an “HU”) mounted in a movable object, such as a vehicle, is a dual-mode terminal having two functions: a function as a master (access point or AP) in a wireless local area network (LAN), and a function as a slave (station or STA) in the wireless LAN. When an HU operates as a master, the HU provides services such as transmission of moving images of, e.g., a digital versatile disc (DVD) to the slave terminal via radio communications, allowing the slave terminal to play the transmitted moving images.

Here, suppose a situation in which a mobile communication terminal (master) anda tablet terminal (slave) are brought into a vehicle in which an HU exists. In this situation, because the network configured by the mobile communication terminal and the tablet terminal via wireless LAN is independent of the network of the HU, the tablet terminal cannot simultaneously receive both the services provided by the HU and the services (the Internet or the like) provided by the mobile communication terminal.

In order to enable the tablet terminal to simultaneously receive the services provided by the HU and the services provided by the mobile communication terminal, it is necessary to connect all of the tablet terminal, the HU, and the mobile communication terminal via wireless LAN. In establishing such connection, the following problems (1) and (2) arise.

(1) The necessity of inputting network connection information, such as service set identifier (SSID) and pass phrase of a master, into the slave is a burden for the user.

In the situation above, the user must input the network connection information about the mobile communication terminal and/or the HU which act (s) as master to the tablet terminal and/or the HU which act (s) as slave. The user must also memorize the plural pieces of network connection information. Thus, the input of the network connection information imposes a heavy burden on the user.

(2) Next, it is necessary to configure the network in such a manner that the tablet terminal can simultaneously receive a service provided by the HU and a service provided by the mobile communication terminal, and that heavy load would not be imposed on the mobile communication terminal.

When the HU and the tablet terminal join the network hosted by the mobile communication terminal acting as master, the service provided by the HU for the tablet terminal needs to be provided by way of the mobile communication terminal, forcing the mobile communication terminal to operate all the time. As a result, the power consumption of the mobile communication terminal is increased, while the transmission rate of the mobile communication terminal is decreased.

Patent literature 1 discloses two networks. The first network includes a master terminal, which operates in master mode, and a dual-mode terminal, which operates in both master and slave modes. The second network includes dual-mode terminals. In addition to these terminals, there is provided a management device connected to the master terminal via a LAN cable. The management device stores the network connection information about each of the terminals, and manages the network configuration.

When one of the dual-mode terminals belonging to the first network desires to change its connection destination to the second network, the dual-mode terminal issues a command to the management device, thereby being able to reconfigure an optimal second network.

However, because the management device reconfigures a network by using the network connection information about the terminals stored in advance, when there is a network or terminal which the management device does not grasp, the management device cannot reconfigure the network. Therefore, the user needs to reconfigure the network manually using the network connection information, and therefore the above-mentioned problem explained in (1) cannot be solved.

In patent literature 2, when a printer operating in slave mode is made to join a network in which a master terminal operating in master mode and a slave terminal operating in slave mode are connected with each other, the printer is made to operate in master mode only at the time of network reconfiguration.

Although in above-mentioned patent literature 2 the printer is made to operate in master mode only at the time of network reconfiguration, a printer is made to operate in master mode at all times in patent literature 3.

Conventionally, the user needs to change the settings of the wireless LAN via which the master terminal, the slave terminal and the printer are connected with one another in accordance with a procedure. In contrast with this, in patent literatures 2 and 3, when the user issues a command to change the connection destination of the slave terminal and the printer, the printer operates in master mode and receives the network connection information from the slave terminal, so that the printer can join the network of the master terminal by using the information. As a result, a network can be reconfigured more easily than that reconfigured in accordance with a conventional setting procedure, and the user's operation burden can be reduced.

However, the user needs to issue a command to change the connection destination of the printer and the slave terminal and input the network connection information of the printer to the slave terminal, and therefore the above-mentioned problem explained in (1) cannot be solved completely.

Further, because the printer and the slave terminal join the network of the master terminal, the master terminal operates at all times. Although a case using a non-portable home router as the master terminal is assumed in patent literature 3, the power consumption as mentioned above in (2) and so on are a problem when a mobile router operating from a battery is used.

### CITATION LIST

### Patent Literature

Patent Literature 1: Japanese Unexamined Patent Application Publication No. 2013-214978

Patent Literature 2: Japanese Unexamined Patent Application Publication No. 2003-143156

Patent Literature 3: Japanese Unexamined Patent Application Publication No. 2007-221808

### SUMMARY OF INVENTION

### Technical Problem

A problem with conventional communication systems is that the operation burden on the user is large at the time of reconfiguring a network, and the operation of making settings is inconvenient for the user, as explained above.

The present invention is made in order to solve the above-explained problem, and it is therefore an object of the present invention to reduce the inconvenience of making settings at the time of reconfiguring a network.

### Solution To Problem

According to the present invention, there is provided a dual-mode communication device that is operable in both master mode and slave mode, the communication device comprising: an information acquirer to acquire network connection information required to join a first wireless network provided by a master terminal from a slave terminal that joins the first wireless network, when a request for connection to a second wireless network provided by the communication device as a master is notified from the slave terminal; and a network configurator to configure anew a third wireless network which at least the communication device, the master terminal and the slave terminal join, using the network connection information acquired by the information acquirer.

### Advantageous Effects of Invention

The communication device according to the present invention acquires network connection information from a slave terminal that has requested to establish a connection, and configures a wireless network. Thus, the communication device can reduce the operation burden on the user and the inconvenience of setup involved in reconfiguring the network.

### BRIEF DESCRIPTION OF DRAWINGS

FIGS. 1A-1C depict a diagram showing an example of network reconfiguration based on a communication system according to Embodiment 1 of the present invention;

FIG. 2 is a diagram showing an example of network configuration as a reference example to help the understanding of Embodiment 1;

FIG. 3 is a block diagram showing the internal configuration of a communication device according to Embodiment 1;

FIG. 4 is a block diagram showing the internal configuration of a slave terminal connected to the communication device via wireless LAN according to Embodiment 1;

FIG. 5 is a flow chart showing the operation of the communication device according to Embodiment 1 at the time of network reconfiguration;

FIG. 6 is a flowchart showing the operation of the slave terminal according to Embodiment 1 at the time of network reconfiguration;

FIG. 7 is a flow chart showing the operation of a master terminal according to Embodiment 1 at the time of network reconfiguration;

FIG. 8 is a flow chart showing the operation of the communication device according to Embodiment 1 at the time of network restoration;

FIG. 9 is a flowchart showing the operation of the slave terminal according to Embodiment 1 at the time of network restoration;

FIG. 10 is a flowchart showing the operation of the master terminal according to Embodiment 1 at the time of r network restoration; and

FIGS. 11A-11C depict a diagram showing an example of network reconfiguration based on a communication system according to Embodiment 2 of the present invention.

### DESCRIPTION OF EMBODIMENTS

Hereinafter, in order to explain the invention in greater detail, embodiments of the present invention will be described with reference to the accompanying drawings.

### Embodiment 1

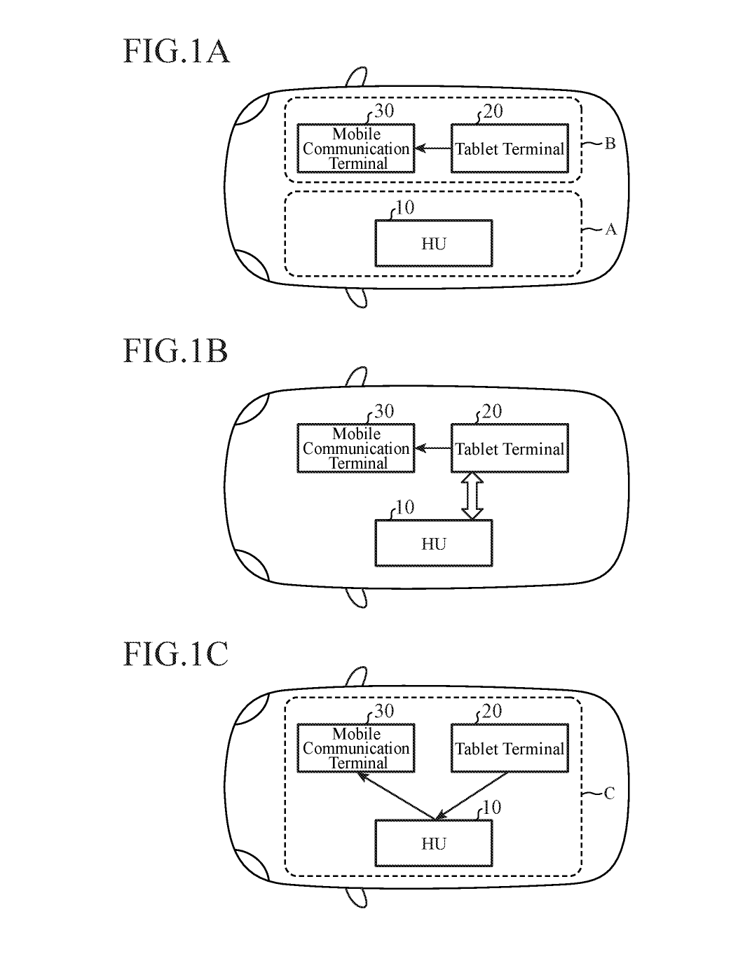

First, an overview of an example of network reconfiguration by using a communication system according to Embodiment 1 will be explained with reference to FIGS. 1A-1C. As shown in FIG. 1, an HU 10 as a communication device according to Embodiment 1 is mounted in a vehicle. The HU 10 is an example of a dual-mode communication device that operates in both master and slave modes. A tablet terminal 20 is an example of a slave terminal that operates in slave mode. A mobile communication terminal 30 is an example of a master terminal that operates in master mode.

Black solid arrows pointing from a slave terminal to a master terminal represent a wireless LAN connection. White double arrows between terminals represent short-range wireless communications, such as near-field communication (NFC).

Here, suppose a situation in which a network A already exists in a vehicle, and in which a network B connecting the tablet terminal 20 to the mobile communication terminal 30 via wireless LAN has been introduced in the vehicle, as shown in FIG. 1A.

In this situation, the tablet terminal 20 can receive a service (e.g., the Internet) provided by the mobile communication terminal 30. By contrast, the tablet terminal 20 cannot receive a service provided by the HU 10 (e.g., playing moving images on the tablet terminal 20 by transmitting the moving images via wireless communications) because the tablet terminal 20 has no wireless LAN connection to the HU 10. In order for the tablet terminal 20 to receive services from both the mobile communication terminal 30 and HU 10, it is necessary to reconfigure the networks.

When the user holds a short-range wireless communication unit of the tablet terminal 20 over a short-range wireless communication unit of the HU 10, short-range wireless communications between the tablet terminal 20 and the HU 10 are initiated as shown in FIG. 1B. This process involves the following merits:

(1) Because this act “holding . . . over” can be interpreted as the user's intention to reconfigure the networks, the user's intention can be easily confirmed.

(2) Network connection information required for reconfiguring the networks can be transmitted or received between the tablet terminal 20 and the HU 10.

Conventional art provided no technique of transmitting the “network connection information of the mobile communication terminal 30,” which is apiece of network connection information required for reconfiguring the networks, from the tablet terminal 20 to the HU 10. By contrast, such technique is realized in Embodiment 1 by providing the tablet terminal 20 with: an application for acquiring “the network connection information about the mobile communication terminal 30”; and a short-range wireless communication function of transmitting the acquired “network connection information of the mobile communication terminal 30” to the HU 10, and receiving the “network connection information of the HU 10” as well. As a result, it is not necessary for the user to manually input network connection information required to reconfigure the networks into both the HU 10 and tablet terminal 20.

FIG. 1C depicts a network C configured anew (hereafter may be referred to as “reconfigured network C”). In this network C, the HU 10 works as a relay unit between the mobile communication terminal 30 and tablet terminal 20. That is, the HU 10 serves as a slave and the mobile communication terminal 30 serves as a master to establish a wireless LAN connection, while the HU 10 serves as a master and the tablet terminal 20 serves as a slave to establish another wireless LAN connection. Data in the network C are transferred from the mobile communication terminal 30 to the tablet terminal 20 via the HU 10, or from the tablet terminal 20 to the mobile communication terminal 30 via the HU 10,.

The configuration of the network C has following advantages.

(1) The tablet terminal 20 can receive the service provided by the mobile communication terminal 30 and the service provided by the HU 10 simultaneously because the tablet terminal 20 is connected to both the mobile communication terminal 30 and HU 10 via wireless LAN.

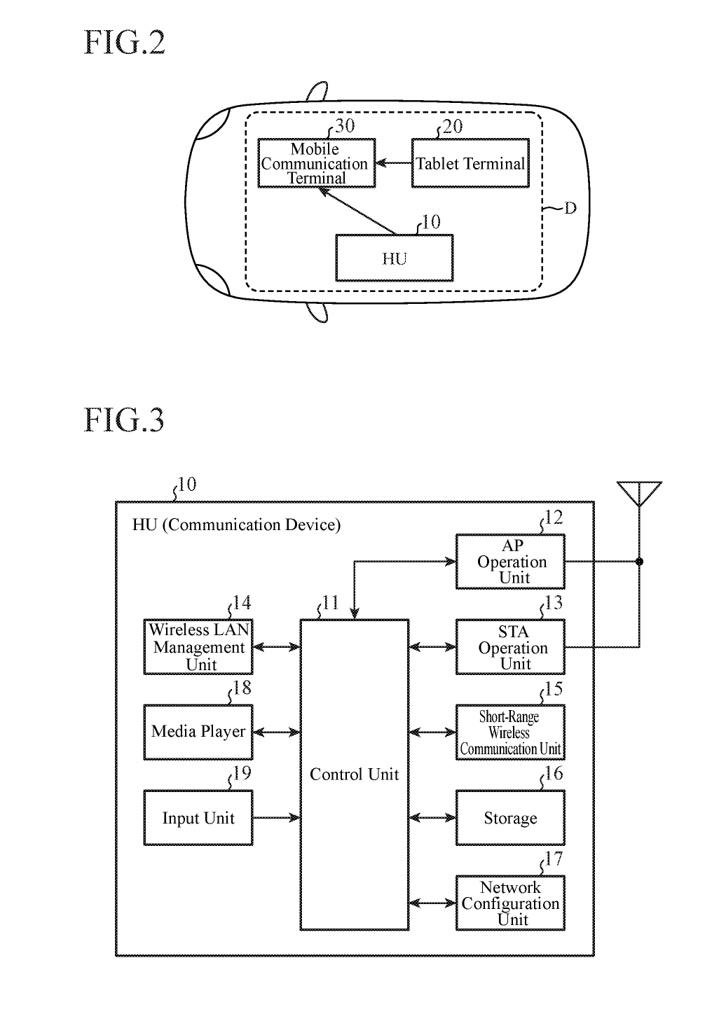

(2) An amount of data which the mobile communication terminal 30 transmits and receives can be reduced in the network C shown in FIG. 1C as compared with a network D shown in FIG. 2, in which the mobile communication terminal 30 serves as a master while the HU 10 and tablet terminal 20 each serve as a slave. Further, an increase in the power consumption of the mobile communication terminal 30 and a decrease in the transmission rate of the mobile communication terminal 30 can be prevented.

In the case of the network D shown in FIG. 2, data are transmitted and received between the mobile communication terminal 30 and the HU 10, and between the mobile communication terminal 30 and the tablet terminal 20. Therefore, when the tablet terminal 20 receives a service provided by the HU 10 the tablet terminal 20 needs to receive the service via the mobile communication terminal 30, and hence the mobile communication terminal 30 is kept operating at all times. As a result, the power consumption of the mobile communication terminal 30 is increased, while the transmission rate of the mobile communication terminal 30 is decreased.

In contrast, in the case of the network C shown in FIG. 1C, when the tablet terminal 20 receives a service provided by the HU 10 there is no need for the service to be provided via the mobile communication terminal 30, and hence the mobile communication terminal 30 transmits and receives data only when providing a service for the tablet terminal 20. Therefore, an increase in the power consumption of the mobile communication terminal 30 and a decrease in the transmission rate of the mobile communication terminal 30 can be prevented.

Next, the HU 10, the tablet terminal 20 and the mobile communication terminal 30 according to Embodiment 1 will be explained in detail.

FIG. 3 is a block diagram showing the internal configuration of the HU 10. The HU 10 includes a control unit 11, an AP operation unit 12, an STA operation unit 13, a wireless LAN management unit 14, a short-range wireless communication unit 15, a storage 16, a network configuration unit 17, a media player 18, and an input unit 19.

The wireless LAN management unit 14 corresponds to a “wireless network manager,” and the short-range wireless communication unit 15 corresponds to an “information acquirer.”

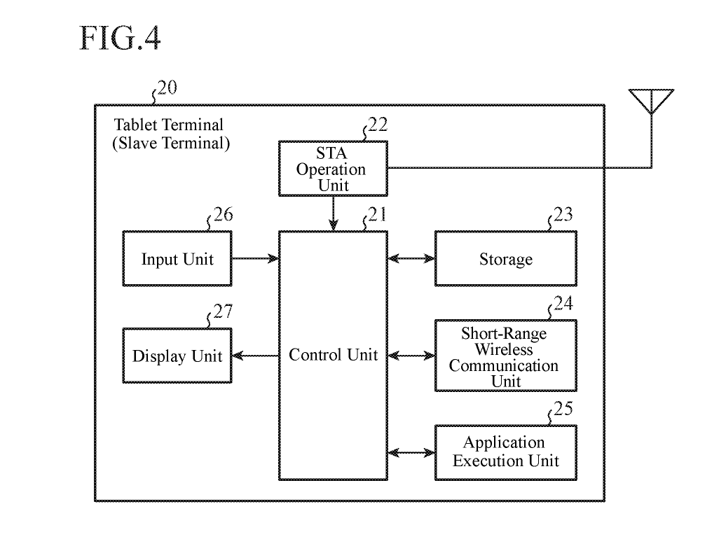

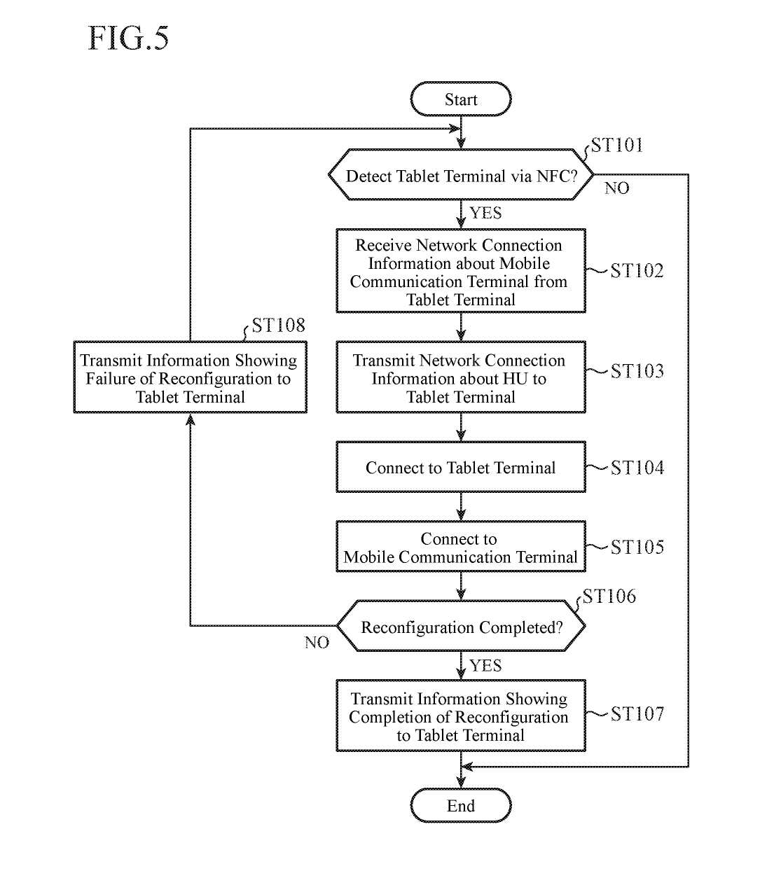

FIG. 4 is a block diagram showing the internal configuration of the tablet terminal 20. The tablet terminal 20 includes a control unit 21, an STA operation unit 22, a storage 23, a short-range wireless communication unit 24, an application execution unit 25, an input unit 26, and a display unit 27.

The HU 10 has the following features.

(1) The HU 10 transmits the network connection information about the master mode of the HU 10 to the tablet terminal 20.

(2) The HU 10 receives the network connection information about the mobile communication terminal 30 from the tablet terminal 20.

(3) The HU 10 establishes a wireless LAN connection to the mobile communication terminal 30 by using the network connection information about the mobile communication terminal 30 received from the tablet terminal 20.

(4) The HU 10 stores an Internet URL at which a reconfiguration application program to be executed by the tablet terminal 20 exists.

(5) The HU 10 manages wireless conditions such as channels in the vehicle, thereby reducing the radio wave interference in the wireless LAN.

The control unit 11 is formed by a central processing unit (CPU) or the like, and controls each of the units within the HU 10.

The AP operation unit 12 and the STA operation unit 13 enable the HU 10 to work as a wireless LAN relay unit between the mobile communication terminal 30 and tablet terminal 20. The AP operation unit 12 operates as a master (AP) at the time of establishing a wireless LAN connection and performing communications with the tablet terminal 20, which is a slave terminal. The STA operation unit 13 operates as a slave (STA) at the time of establishing a wireless LAN connection and performing communications with the mobile communication terminal 30.

The wireless LAN management unit 14 manages the channels and so on of pieces of wireless communication equipment used in the vehicle. To prevent radio wave interference in the wireless LAN which brings about a communication failure, the wireless LAN management unit 14 monitors the radio wave intensity of the antenna, and assigns at least one of an appropriate channel (frequency band) and time (communication timing) to both the AP operation unit 12 and the STA operation unit 13.

Here, an example of the operation of the wireless LAN management unit 14 will be explained.

In the beginning, the wireless LAN management unit 14 scans the channel information of communication equipment in the vehicle via the antenna of the HU 10, the AP operation unit 12, and the STA operation unit 13. The wireless LAN management unit 14 then selects as candidates several channels which cause no radio frequency interference on the basis of the scanned channel information, and uses one of the candidate channels for wireless LAN communications between the mobile communication terminal 30 and the STA operation unit 13. The wireless LAN management unit 14 also selects a channel to be used for wireless LAN communications between the tablet terminal 20 and the AP operation unit 12 from the remaining candidate channels, and generates information about the selected channel. The wireless LAN management unit 14 notifies the tablet terminal 20 of this generated channel information via the short-range wireless communication unit 15, which will be described later.

The short-range wireless communication unit 15 is a unit for performing short-range wireless communications with the short-range wireless communication unit 24 of the tablet terminal 20. To perform short-range wireless communication, a technology, such as near-field communication (NFC), infrared light, or Bluetooth (registered trademark), is used.

This short-range wireless communication unit 15 is unable to perform communications with the tablet terminal 20 when the tablet terminal 20 is too far from the short-range wireless communication unit 15. For example, as for NFC, it is difficult to perform communications if the distance between the short-range wireless communication unit 15 and the tablet terminal 20 is equal to or larger than 10 cm. Accordingly, the user needs to bring the tablet terminal 20 close to the short-range wireless communication unit 15 of the HU 10. This user's operation “bringing . . . close” serves as confirmation of the user's intention to reconfigure the networks, so that an input operation using a button or the like can be eliminated to confirm user's intention.

When the user brings the tablet terminal 20 close to the HU 10, the short-range wireless communication unit 15 detects the tablet terminal 20 to start short-range wireless communications. The control unit 11 regards this user's operation as a connection request from the tablet terminal 20, and instructs the network configuration unit 17 to reconfigure the networks.

The storage 16 stores the Internet URL at which the reconfiguration application program exists, and the network connection information such as the SSID of the AP operation unit 12 about the HU 10; the short-range wireless communication unit 15 can transmit the Internet URL and the network connection information to the tablet terminal 20. The short-range wireless communication unit 15 can also receive the network connection information such as SSID about the mobile communication terminal 30 from the tablet terminal 20.

For example, in the case of NFC, when the user holds the tablet terminal 20, in which a reconfiguration application is already activated, over the short-range wireless communication unit 15 of the HU 10, the short-range wireless communication unit 15 of the HU 10 receives the network connection information about the mobile communication terminal 30 from the short-range wireless communication unit 24 of the tablet terminal 20, and also transmits the network connection information about the HU 10 to the short-range wireless communication unit 24 of the tablet terminal 20.

Further, for example, in the case of infrared light, when the user directs the tablet terminal 20, in which a reconfiguration application is already activated, toward the short-range wireless communication unit 15 of the HU 10, the short-range wireless communication unit 15 of the HU 10 receives the network connection information about the mobile communication terminal 30 from the short-range wireless communication unit 24 of the tablet terminal 20, and also transmits the network connection information about the HU 10 to the short-range wireless communication unit 24 of the tablet terminal 20.

Further, for example, in the case of Bluetooth (registered trademark), when the user carries the tablet terminal 20, in which a reconfiguration application is already activated, into the vehicle to enter the range of the wireless communications of the HU 10, or when the user activates a reconfiguration application on the tablet terminal 20 in the vehicle, wireless communications start between the short-range wireless communication unit 24 of the tablet terminal 20 and the short-range wireless communication unit 15 of the HU 10. Then, the short-range wireless communication unit 15 of the HU 10 receives the network connection information about the mobile communication terminal 30 from the short-range wireless communication unit 24 of the tablet terminal 20, and also transmits the network connection information about the HU 10 to the short-range wireless communication unit 24 of the tablet terminal 20.

The storage 16 is a unit that may be implemented as a hard disk drive (HDD) and/or a semiconductor memory. This storage stores information, including the network connection information about the AP operation unit 12, the network connection information about the mobile communication terminal 30, the Internet URL at which the reconfiguration application program to be executed by the tablet terminal 20 exists, and the network configuration information before reconfiguring the networks.

The short-range wireless communication unit 15 acquires the network connection information about the mobile communication terminal 30, and the network configuration unit 17 uses the information when reconfiguring the networks.

The reconfiguration application program is prepared to be acquired from a Web server via the Internet. The short-range wireless communication unit 15 of the HU 10 transmits the URL of the reconfiguration application program to the tablet terminal 20, thereby enabling the tablet terminal 20 to download and execute the reconfiguration application program on site.

Note that the storage 16 may store the reconfiguration application program, and the tablet terminal 20 may acquire the reconfiguration application program directly from the storage 16 of the HU 10.

According to the present invention, it is also possible to return the network configuration of a reconfigured network (e.g., the network shown in FIG. 1C) to that of an original network before reconfiguration (e.g., the network shown in FIG. 1A). To this end, the storage 16 stores network connection information about terminals (not shown) which had connected to the HU 10 via wireless LAN before reconfiguring the network as the network configuration information before reconfiguration.

The short-range wireless communication unit 15 may acquire the network connection information about the mobile communication terminal 30 of the previous network configuration, and the network configuration unit 17 uses the information when restoring the network.

The network configuration unit 17 changes wireless LAN settings. Wireless LAN settings need to be changed when networks as shown in FIG. 1A are reconfigured to a network as shown in FIG. 1C, and when the network configuration of the reconfigured network is returned to that of the original networks.

When reconfiguring the network, the network configuration unit 17 uses the network connection information about the mobile communication terminal 30 stored in the storage 16 to change the wireless LAN settings on the STA operation unit 13. As a result, the STA operation unit 13 establishes a wireless LAN connection to the mobile communication terminal 30.

A wireless LAN connection between the AP operation unit 12 and tablet terminal 20 is established by the reconfiguration application executed on the tablet terminal 20. More specifically, when the wireless LAN settings are changed by the function of the reconfiguration application in the tablet terminal 20, the AP operation unit 12 of the HU 10 and the tablet terminal 20 establish a wireless LAN connection with each other.

When network reconfiguration is completed, the network configuration unit 17 notifies the tablet terminal 20 via the wireless LAN that network reconfiguration is completed.

When restoring the network configuration to the previous one (s), the network configuration unit 17 uses the network configuration information stored in the storage 16. By changing the wireless LAN settings on the basis of the stored information, the network configuration unit 17 disconnects connections between the HU 10 and the terminals established after reconfiguration, and establishes connections between the HU 10 and the terminals that had connected to the HU 10 before reconfiguration.

The media player 18 reads content data from a storage medium, such as a DVD, a Compact Disc (CD), an HDD or a semiconductor memory, and plays back the content data.

The control unit 11 transmits the content data played back by the media player 18 to the tablet terminal 20 via wireless LAN communications performed by the AP operation unit 12, enabling the tablet terminal 20 to play back the content data.

The input unit 19 is implemented as an input device such as buttons. When the user desires to return the network configuration of the reconfigured network to that of the original network(s), the user inputs a command for restoring the network configuration by, for example, pressing down a button of the input unit 19.

In response to receiving the command for restoring the network configuration through the input unit 19, the control unit 11 commands the network configuration unit 17 to return the network configuration to the original one(s).

The tablet terminal 20 has the following features.

(1) The tablet terminal 20 receives the network connection information about the master mode of the HU 10 from the HU 10.

(2) The tablet terminal 20 stores the network connection information about the mobile communication terminal 30 which is previously registered.

(3) The tablet terminal 20 transmits the network connection information about the mobile communication terminal 30 which is previously registered to the HU 10.

The control unit 21 may be implemented as a CPU or the like, and controls each of the units within the tablet terminal 20.

The STA operation unit 22 operates as a slave when establishing a wireless LAN connection to a master, and when communicating with the master. The master mentioned here refers to the AP operation unit 12 of the HU 10 or the mobile communication terminal 30.

The storage 23 is a unit that may be implemented as an HDD and/or a semiconductor memory. This storage 23 stores information, including the reconfiguration application program, and the network connection information about the mobile communication terminal 30 to which the tablet terminal had connected via a wireless LAN before network reconfiguration.

The reconfiguration application program is a program for reconfiguring networks. The reconfiguration application program is used by the application execution unit 25 at the time of network reconfiguration.

The network connection information about the mobile communication terminal 30 is information that was used by the STA operation unit 22 to establish a wireless LAN connection between the tablet terminal 20 and the mobile communication terminal 30. This network connection information was inputted in the past by the user in order to configure the network B shown in FIG. 1A, and the user does not need to input the information again when conducting network reconfiguration to configure the network C shown in FIG. 1C.

The short-range wireless communication unit 24 has functions similar to those of the short-range wireless communication unit 15 mounted in the HU 10. The purpose of the short-range wireless communication unit 24 is to transmit the network connection information about the mobile communication terminal 30 stored in the storage 23 to the short-range wireless communication unit 15 of the HU 10, and to receive the network connection information about the HU 10 from the short-range wireless communication unit 15.

Further, in the case in which the reconfiguration application program is not stored in the storage 23, the short-range wireless communication unit 24 receives the

Internet URL at which the reconfiguration application program exists from the short-range wireless communication unit 15 of the HU 10 when triggered by the user's operation of bringing the tablet terminal 20 close to the HU 10.

Based on the URL, the control unit 21 downloads the reconfiguration application program through wireless LAN communications between the STA operation unit 22 and the mobile communication terminal 30, and stores the reconfiguration application program in the storage 23.

The application execution unit 25 executes the reconfiguration application. For example, the CPU which embodies the control unit 21 implements the function as the application execution unit 25 by executing the reconfiguration application program.

The application execution unit 25 operates as follows by executing the reconfiguration application.

Upon activation of the reconfiguration application, the application execution unit 25 prompts the user to bring the short-range wireless communication unit 24 of the tablet terminal 20 close to the short-range wireless communication unit 15 of the HU 10. The way prompting the user may take any form. For example, the application execution unit 25 may cause the display unit 27 to display a text message or the like, or a speaker (not-shown) to output an audio message.

While the user holds the short-range wireless communication unit 24 of the tablet terminal 20 close to the short-range wireless communication unit 15 of the HU 10, the application execution unit 25 transmits the network connection information about the mobile communication terminal 30 stored in the storage 23 to the HU 10 via the short-range wireless communication unit 24, and also receives the network connection information about the HU 10 from the HU 10.

The application execution unit 25 changes the wireless LAN settings of the STA operation unit 22, using the received network connection information about the HU 10. As a result, the STA operation unit 22 establishes a wireless LAN connection to the AP operation unit 12 of the HU 10.

Further, to restore the reconfigured network to its original network(s), the application execution unit 25 first receives the command to “restore the network” from the HU 10 via the wireless LAN communications. And then the application execution unit 25 changes the wireless LAN settings of the STA operation unit 22, using the network connection information, stored in the storage 23, about the mobile communication terminal 30 to which the tablet terminal had connected via a wireless LAN before reconfiguration. As a result, the STA operation unit 22 establishes a wireless LAN connection to the mobile communication terminal 30.

The input unit 26 includes an input device such as a touch panel. When the user wants to reconfigure the network, the user operates the touch panel of the input unit 26 to activate the reconfiguration application.

When the command to activate the reconfiguration application is inputted to the input unit 26, the control unit 21 commands the application execution unit 25 to activate the reconfiguration application.

The display unit 27 includes a display. The display of the display unit 27 and the touch panel of the input unit 26 may be formed integrally.

When the application execution unit 25 executes the reconfiguration application, the display unit 27 may display on the screen, for example, a destination node to which the reconfigured network connects and/or information of completing the reconfiguration. The display unit 27 also displays the content data transmitted from the HU 10 under control by the control unit 21.

Next, the operations of the HU 10, the tablet terminal 20 and the mobile communication terminal 30 according to Embodiment 1 will be explained. First, operations at the time of network reconfiguration will be explained. After that, operations of returning the network configuration of the reconfigured network to the original network(s) will be explained.

FIG. 5 is a flow chart showing the operation of the HU 10 at the time of network reconfiguration.

Hereafter, the explanation will be made by taking, as an example, a case in which the reconfiguration application program is preinstalled in the tablet terminal 20, and NFC is used for short-range wireless communication.

In the state in which networks are configured as shown in FIG. 1A, the user holds the tablet terminal 20 in which the reconfiguration application is activated over the short-range wireless communication unit 15 of the HU 10, as shown in FIG. 1B. In step ST101, the short-range wireless communication unit 15 detects devices to which communications are possible using NFC. In the exemplary embodiment, the short-range wireless communication unit 15 detects the tablet terminal 20, which is held over the short-range wireless communication unit 15.

In step ST102, the short-range wireless communication unit 15 receives the network connection information about the mobile communication terminal 30 from the tablet terminal 20 via the wireless communications using NFC while the tablet terminal 20 is being held over the short-range wireless communication unit 15. The short-range wireless communication unit 15 stores the received network connection information about the mobile communication terminal 30 in the storage 16.

In step ST103, the short-range wireless communication unit 15 transmits the network connection information about the HU 10 to the tablet terminal 20 via the wireless communications using NFC while the tablet terminal 20 is being held over the short-range wireless communication unit 15.

Channel information determined by the wireless LAN management unit 14 may be included in the transmitted network connection information.

The tablet terminal 20 changes the wireless LAN settings by using the received network connection information about the HU 10, disconnecting the wireless LAN connection between the tablet terminal 20 and the mobile communication terminal 30. Then, in step ST104, a wireless LAN connection between the AP operation unit 12 of the HU 10 and the tablet terminal 20 is established.

Instep ST105, the network configuration unit 17 changes the wireless LAN settings by using the network connection information about the mobile communication terminal 30 stored in the storage 16, and establishes a wireless LAN connection to the mobile communication terminal 30.

When the network C as shown in FIG. 1C has been configured (“YES” in step ST106), the network configuration unit 17 transmits information indicating that network reconfiguration has been completed to the tablet terminal 20 via the wireless LAN communication performed by the AP operation unit 12 (in step ST107), and then ends the processing of FIG. 5.

In contrast, when the network configuration unit 17 fails to configure the network C (“NO” in step ST106), and if the AP operation unit 12 and the tablet terminal 20 are connected with each other via wireless LAN, the network configuration unit 17 transmits information indicating that network reconfiguration has been failed to the tablet terminal 20 via wireless LAN (in step ST108), and returns to step ST101. Note that if establishment of a wireless LAN connection between the AP operation unit 12 and the tablet terminal 20 has been failed, the network configuration unit 17 skips step ST108 and returns to step ST101.

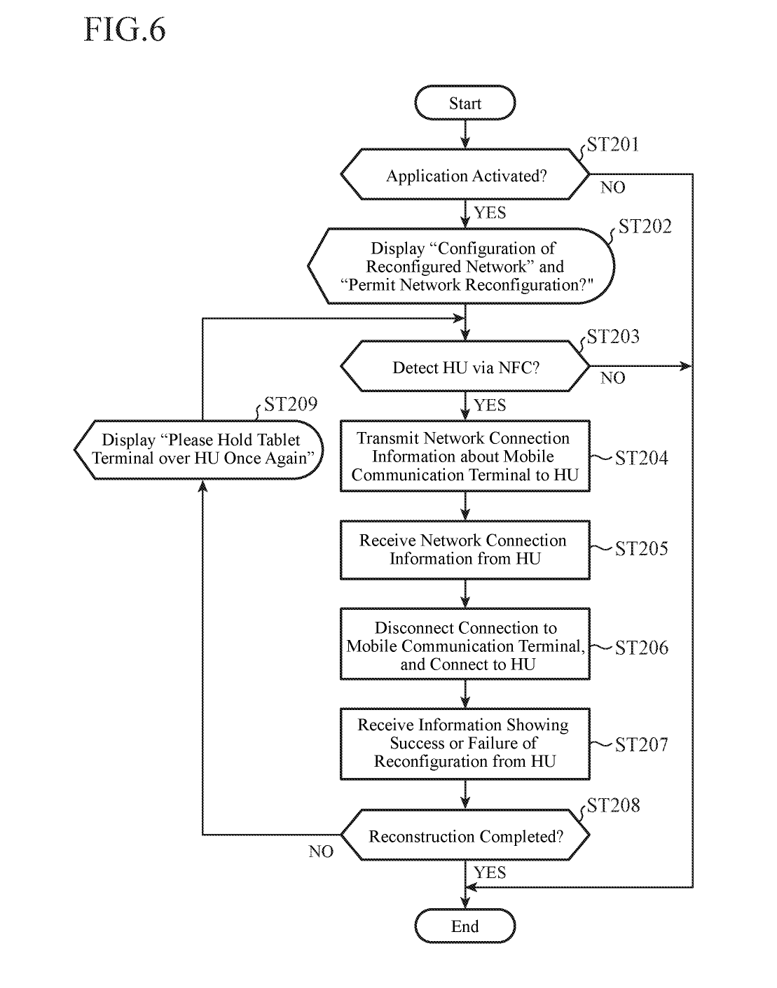

FIG. 6 is a flowchart showing the operation of the tablet terminal 20 at the time of the network reconfiguration.

Also hereinafter, the explanation will be made by taking, as an example, the case in which the reconfiguration application program is preinstalled in the tablet terminal 20, and NFC is used for short-range wireless communications, as in the case of FIG. 5.

In the state in which networks are configured as shown in FIG. 1A, the user inputs a command to activate the reconfiguration application to the input unit 26 of the tablet terminal 20. In step ST201, the application execution unit 25 activates the reconfiguration application in accordance with the user's command. After activating the reconfiguration application, the application execution unit 25 first stores the network connection information about the mobile communication terminal 30 to which the tablet terminal 20 currently connects via wireless LAN in the storage 23.

In step ST202, the application execution unit 25, displays on the screen of the display unit 27 a display that relates to “configuration of reconfigured network” and “permission of network reconfiguration.”

For example, the application execution unit 25 displays on the screen messages, such as “Do you want to reconfigure the network from ‘mobile communication terminal←tablet terminal’ to ‘mobile communication terminal←HU←tablet terminal?’” and “Hold your tablet terminal over HU if you permit network reconfiguration.”

When the user holds the short-range wireless communication unit 24 of the tablet terminal 20 over the short-range wireless communication unit 15 of the HU 10 in accordance with the display shown by the display unit 27, the short-range wireless communication unit 24 detects the HU 10 to which the tablet terminal 20 can perform wireless communications using NFC in step ST203.

Thus, through a simple operation for the user of holding the tablet terminal 20 over the HU 10, the tablet terminal 20 can detect the HU 10 and also confirm the user's permission of network reconfiguration.

In step ST204, the application execution unit 25 transmits the network connection information about the mobile communication terminal 30 stored in the storage 23 to the HU 10 via the wireless communications using NFC while the tablet terminal 20 is being held over the HU 10.

In step ST205, the application execution unit 25 receives the network connection information about the HU 10 from the HU 10 via the wireless communications using NFC while the tablet terminal 20 is being held over the HU 10. The application execution unit 25 stores the received network connection information about the HU 10 in the storage 23.

Instep ST206, the application execution unit 25 changes the wireless LAN settings by using the network connection information about the HU 10 stored in the storage 23. As a result, the STA operation unit 22 disconnects the wireless LAN connection to the mobile communication terminal 30, and establishes a wireless LAN connection to the HU 10.

In step ST207, the application execution unit 25 receives the information that indicates whether the network reconfiguration has been completed or failed from the HU 10 via the wireless LAN communications performed by the STA operation unit 22. The information showing the completion of the reconfiguration is that transmitted by the HU 10 in step ST107 of FIG. 5, and the information showing the failure of the reconfiguration is that transmitted by the HU 10 in step ST108 of FIG. 5.

When receiving the information showing the completion of the reconfiguration (“YES” in step ST208), the application execution unit 25 ends the processing of FIG. 6.

In contrast, when receiving the information showing the failure of the reconfiguration (“NO” in step ST208), the application execution unit 25 displays on the display unit 27 messages, such as “Failure in network reconfiguration” and “Please hold tablet terminal over HU once again” (step ST209), and returns to step ST203.

Although in the example shown in FIG. 6, the application execution unit provides the various notifications for the user by display, notifications may be provided by other means such as voice.

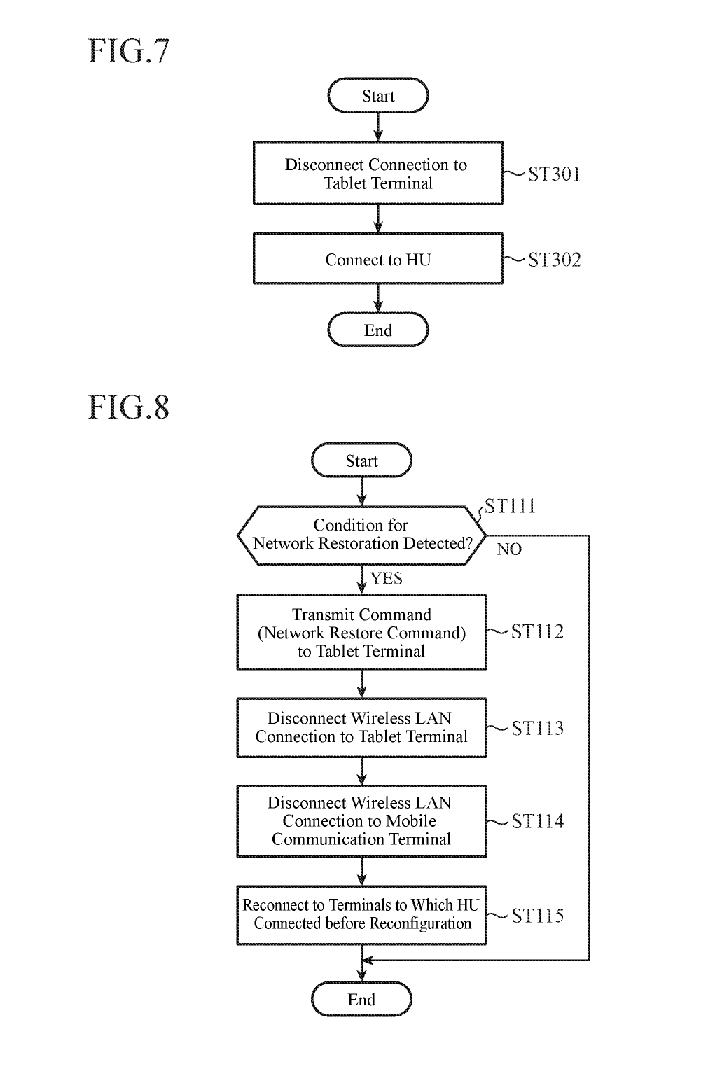

FIG. 7 is a flowchart showing the operation of the mobile communication terminal 30 at the time of network reconfiguration.

When the tablet terminal 20, in step ST206 of FIG. 6, changes the wireless LAN settings in the state in which the networks A and B shown in FIG. 1A exist, the wireless LAN connection between the tablet terminal 20 and the mobile communication terminal 30 is disconnected (step ST301).

When the HU 10, in step ST105 of FIG. 5, changes the wireless LAN settings of the STA operation unit 13, a wireless LAN connection between the STA operation unit 13 of the HU 10 and the mobile communication terminal 30 is established (step ST302).

FIG. 8 is a flow chart showing the operation of the HU 10 when restoring network connectivity of the reconfigured network to that of the original networks.

When detecting a condition for network restoration about the reconfigured network (“YES” in step ST111), the network configuration unit 17 performs processes of steps ST112 to ST115. In contrast, when detecting no such condition (“NO” in step ST111), the network configuration unit 17 ends the processing of FIG. 8.

As for the HU 10, the condition for network restoration includes at least one of the following specific conditions (1) to (5).

(1) The HU 10 receives a request to restore the network from the tablet terminal 20 via wireless LAN communications.

When, for example, the user gets off the vehicle, the user inputs permission to restore the network into the input unit 26 of the tablet terminal 20. The application execution unit 25 that receives the permission transmits a request to restore the network to the HU 10 via the STA operation unit 22. When receiving this request, the AP operation unit 12 of the HU 10 notifies the network configuration unit 17 of the request.

(2) The short-range wireless communication unit 15 of the HU 10 detects the short-range wireless communication unit 24 of the tablet terminal 20 in the reconfigured network.

When the user performs an operation of bringing the tablet terminal 20 close to the short-range wireless communication unit 15 of the HU 10 in the situation in which the network is reconfigured, the HU 10 regards this operation as the intention to restore the network. More specifically, when detecting the tablet terminal 20 in the reconfigured network, the short-range wireless communication unit 15 notifies the detection to the network configuration unit 17.

(3) The user inputs permission to restore the network into the input unit 19 of the HU 10.

Although in the above-described case (1) or (2) the user inputs permission to restore the network into the tablet terminal 20, the user may input his/her permission into the HU 10. In the case of the condition (3), when the user inputs permission to restore the network into the input unit 19 of the HU 10, the permission is notified to the network configuration unit 17.

(4) Decrease in the intensities of radio waves of the wireless LAN received by the AP operation unit 12 and STA operation unit 13 is detected.

The wireless LAN management unit 14 monitors the intensity of radio waves of the wireless LAN between the AP operation unit 12 and the tablet terminal 20, and the intensity of radio waves of the wireless LAN between the STA operation unit 13 and the mobile communication terminal 30. When either or both of the radio wave intensities monitored decreases below a preset threshold, the wireless LAN management unit 14 commands the network configuration unit 17 to restore network configuration to original ones.

(5) Decrease in the transmission rates of the wireless LAN between the AP operation unit 12 and STA operation unit 13 is detected.

The control unit 11 monitors the transmission rates when controlling the data that are transmitted and received between the AP operation unit 12 and the tablet terminal 20, or the data that are transmitted and received between the STA operation unit 13 and the mobile communication terminal 30. When either or both of the transmission rates monitored decreases below a preset threshold, the control unit 11 determines that the wireless LAN connection is unstable, and commands the network configuration unit 17 to restore network configuration to the original ones.

When detecting one of the above-explained conditions (1) to (5) (“YES” in step ST111), the network configuration unit 17 transmits a command to return the reconfigured network to the original networks to the tablet terminal 20 via wireless LAN communications in step ST112.

When receiving the command to restore the network from the HU 10, the tablet terminal 20 changes the wireless LAN settings using the network connection information stored in the storage 23 about the mobile communication terminal 30 which the tablet terminal 20 had connected to before reconfiguring the network. As a result, the wireless LAN connection (in the reconfigured network) between the tablet terminal 20 and the HU 10 is disconnected (step ST113).

In step ST114, the network configuration unit 17 changes the wireless LAN settings in the STA operation unit 13, and disconnects the wireless LAN connection to the mobile communication terminal 30.

If network connection information about terminals which the HU had connected to before the network reconfiguration (i.e., network configuration information before the network reconfiguration) is stored in the storage 16, the network configuration unit 17 changes the wireless LAN settings by using the stored network connection information in step ST115. As a result, the HU 10 establishes a wireless LAN connection to the terminal which the HU had connected to before the network reconfiguration.

Note that if no such network connection information before network reconfiguration exists, the network configuration unit 17 ends the processing of FIG. 8 without performing the process of step ST115.

As a result, the network configuration returns from the network C shown in FIG. 1C to the network A shown in FIG. 1A which existed before configuring the network C.

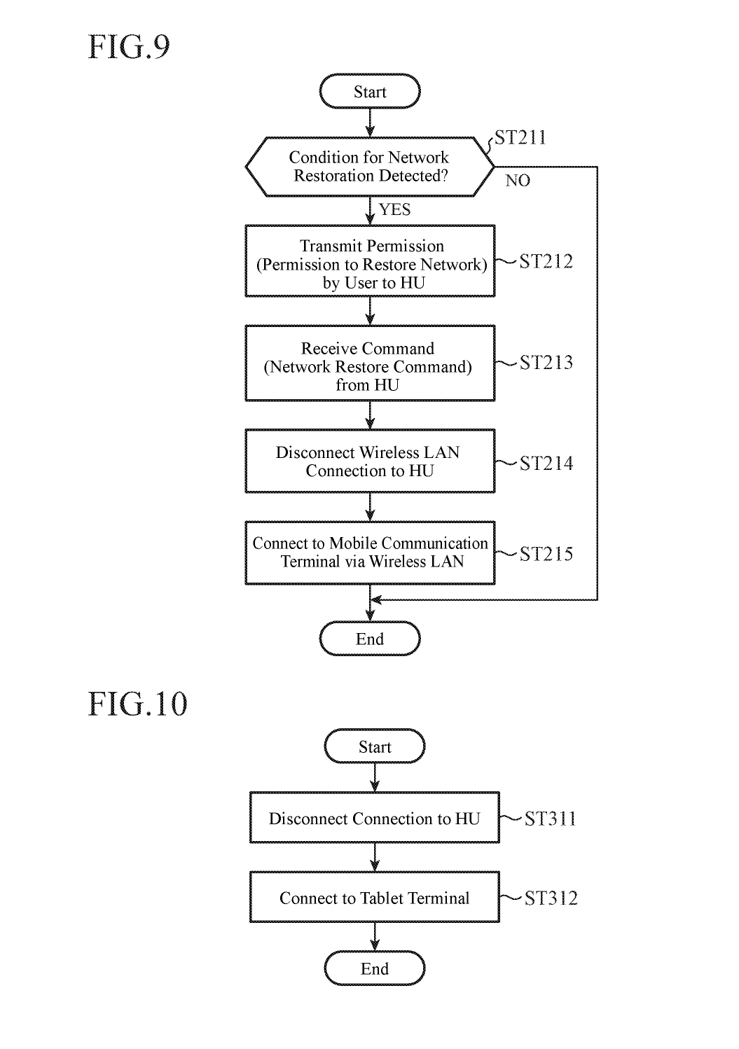

FIG. 9 is a flowchart showing the operation of the tablet terminal 20 when it returns the network configuration of the reconfigured network to that of the original one.

When detecting a condition for returning the reconfigured network to the original one (“YES” in step ST211), the application execution unit 25 performs processes of steps ST212 to 215. In contrast, when detecting no such condition (“NO” in step ST211), the application execution unit 25 ends the processing of FIG. 9.

As for the tablet terminal 20, the condition for network restoration includes the following specific condition (1).

(1) The user inputs permission to restore the network into the input unit 26 of the tablet terminal 20.

Because this condition corresponds to the condition (1) shown in step ST111 of FIG. 8, a detailed explanation of the condition will be omitted hereafter.

When receiving the permission for network restoration from the user via the input unit 26 (“YES” in step ST211), the application execution unit 25, in step ST212, transmits a request to return the network configuration to the original networks to the HU 10 via wireless LAN communications performed by the STA operation unit 22.

The application execution unit 25, in step ST213, receives the command to return the network configuration to the original network from the HU 10 via the wireless LAN communications performed by the STA operation unit 22. This command to return the network configuration to the original one is that transmitted by the HU 10 in step ST112 of FIG. 8.

When receiving the command to return the reconfigured network to the original one, the application execution unit 25 changes the wireless LAN settings in the STA operation unit 22 using the network connection information stored in the storage 23 about the mobile communication terminal 30 which the tablet terminal had connected to before the network reconfiguration.

As a result, the wireless LAN connection between the tablet terminal 20 and the HU 10 is disconnected (step ST214). Further, a wireless LAN connection between the tablet terminal 20 and the mobile communication terminal 30 is established (step ST215).

As a result, the network configuration of the tablet terminal 20 returns from the network C shown in FIG. 1C to the network B shown in FIG. 1A which existed before configuring the network C.

FIG. 10 is a flow chart showing the operation of the mobile communication terminal 30 when it returns the network configuration of the reconfigured network to that of the original one.

When the HU 10, in step ST114 of FIG. 8, changes the wireless LAN settings of the STA operation unit 13 in the network C shown in FIG. 1C, the wireless LAN connection between the STA operation unit 13 of the HU 10 and the mobile communication terminal 30 is disconnected (step ST311).

When the tablet terminal 20, in step ST215 of FIG. 9, changes the wireless LAN settings, a wireless LAN connection between the tablet terminal 20 and the mobile communication terminal 30 is established (step ST312).

As a result, the network configuration of the mobile communication terminal 30 returns from that of the network C shown in FIG. 1C to that of the network B shown in FIG. 1A which existed before reconfiguring the network C.

As explained above, the HU 10 according to Embodiment 1 is configured to include the short-range wireless communication unit 15 that, when a request to connect to the network which the HU 10 provides as a master is notified from the tablet terminal 20 joining the network provided by the mobile communication terminal 30, acquires the network connection information required to join the network provided by the mobile communication terminal 30 from the tablet terminal 20. Further, the HU 10 according to Embodiment 1 is also configured to include the network configuration unit 17 that configures a network which at least the HU 10, the tablet terminal 20 and the mobile communication terminal 30 join, by using the network connection information acquired by the short-range wireless communication unit 15. As a result, the operation burden on the user at the time of reconfiguring the network can be reduced, and the inconvenience involved in making settings can be reduced.

Further, according to Embodiment 1, the reconfigured network is configured in such a manner that the HU 10 relays communications between the mobile communication terminal 30 and the tablet terminal 20. Although an increase in the number of terminals connected to the mobile communication terminal 30 causes an increase in the consumption of the battery and a decrease in the transmission rate, by causing the HU 10 to serve as a relay unit, the number of terminals connected to the mobile communication terminal 30 can be reduced, and an increase in the consumption of the battery and a decrease in the transmission rate can be prevented.

Further, the HU 10 according to Embodiment 1 is configured to include the wireless LAN management unit 14 that manages the frequency band (channel) or the communication timing, which is used in the reconfigured network, to prevent radio wave interference. By aggregating information of the wireless communication equipment used in the vehicle, such as channel, to the HU 10, an appropriate channel and an appropriate time can be assigned to prevent radio wave interference which may result in a communication failure.

Further, the short-range wireless communication unit 15 of the HU 10 according to Embodiment 1 is configured to receive a connection request and network connection information from the tablet terminal 20 via short-range wireless communications. As a result, the user's intention to reconfigure the networks can be confirmed through a simple operation of bringing the tablet terminal 20 close to the HU 10. Further, because the network connection information required for reconfiguring the networks is transmitted and received between the HU 10 and the tablet terminal 20, the user does not have to memorize the network connection information or input the network connection information to each terminal.

Further, a notification from the tablet terminal 20 to the HU 10 of a connection request to the network provided by the AP operation unit 12 of the HU 10 may trigger the tablet terminal 20 according to Embodiment 1 to acquire the reconfiguration application program from an external source. The application execution unit 25 operates in accordance with the acquired reconfiguration application program, and the tablet terminal 20 notifies the HU 10 of the network connection information which has been used to join the network provided by the mobile communication terminal 30. Thus, even if the reconfiguration application is not preinstalled in the tablet terminal 20, the reconfiguration application can be acquired easily within the vehicle.

Further, the tablet terminal 20 according to Embodiment 1 is configured to include the storage 23 that stores the network connection information used to join the network provided by the mobile communication terminal 30. Accordingly, when the connection to the reconfigured network is disconnected, the tablet terminal 20 can rejoin the network provided by the mobile communication terminal 30 using the network connection information stored in the storage 23. As a result, the operation burden on the user at the time of switching from the reconfigured network to the original one can be reduced, and the inconvenience of making settings can be reduced.

### Embodiment 2

In the above-described Embodiment 1, the case in which a single tablet terminal 20 connects to the AP operation unit 12 of the HU 10 via a wireless LAN is described. In the Embodiment 2, a case in which plural tablet terminals 20 establish a wireless LAN connection to an HU is explained.

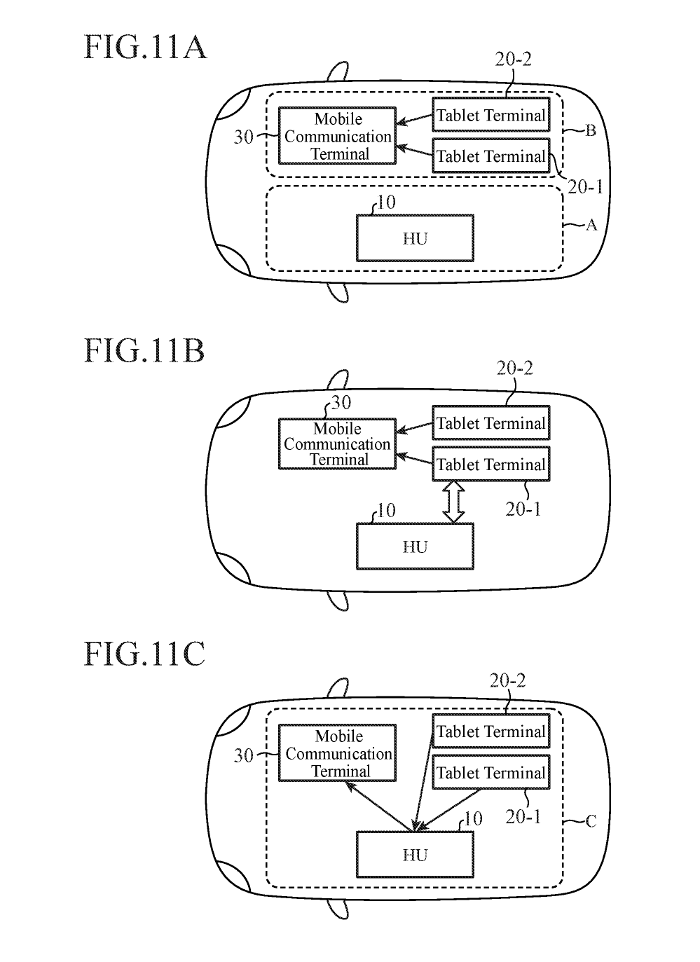

With reference to FIG. 11, an overview of an example of network configuration that uses a communication system according to Embodiment 2 will be explained. In FIG. 11A, a situation in which a network B in which a mobile communication terminal 30 and tablet terminals 20-1 and 20-2 are connected with one another via wireless LAN is carried into a vehicle in which a network A of the HU 10 exists is assumed. FIG. 11C shows a network C configured anew.

Because the internal configuration of the HU 10 according to Embodiment 2 is the same as that shown in FIG. 3, and the internal configuration of each of the tablet terminals 20-1 and 20-2 is the same as that shown in FIG. 4, an explanation will be made using the reference numerals shown in FIGS. 3 and 4. It is further assumed that a reconfiguration application program is preinstalled in each of the tablet terminals 20-1 and 20-2.

Hereafter, in the flow charts shown in FIGS. 5 to 10, operations that are different from those shown in Embodiment 1 will be mainly explained.

In the situation shown in FIG. 11A, a network configuration unit 17 of the HU 10 performs network reconfiguration (steps ST102 to ST108) when triggered by a near-field communication between the HU 10 and one of the tablet terminals 20-1 and 20-2(step ST101 of FIG. 5).

In the example shown in FIG. 11B, the tablet terminal 20-1 performs near-field communications with a short-range wireless communication unit 15 of the HU 10, while the tablet terminal 20-2 does not perform near-field communications with the HU 10.

In step ST102, the network configuration unit 17 receives the network connection information about the mobile communication terminal 30 from the tablet terminal 20-1 via near-field communications.

In step ST103, the network configuration unit 17 transmits the network connection information about an AP operation unit 12 of the HU 10 to the tablet terminal 20-1 via near-field communications.

The tablet terminal 20-1 transmits the network connection information about the HU 10 received from the HU 10 to the tablet terminal 20-2 via wireless LAN communications. When the tablet terminals 20-1 and 20-2 change the wireless LAN connection settings thereof, the AP operation unit 12 establishes wireless LAN connections to the tablet terminal 20-1 or 20-2 in step ST104.

In step ST107 or ST108, the network configuration unit transmits information about completion or failure of reconfiguration to the tablet terminal 20-1 and/or 20-2 via wireless LAN communications.

An application execution unit 25 of the tablet terminal 20-1 performs network reconfiguration (steps ST204 to ST209) when triggered by a near-field communication with the HU 10 (step ST203 of FIG. 6)

In step ST203, the application execution unit 25 of the tablet terminal 20-1 transmits a command to perform network reconfiguration to the other tablet terminals 20-2 via wireless LAN communications with the mobile communication terminal 30.

When receiving the command to perform network reconfiguration from the tablet terminal 20-1 instead of skipping the process in step ST203, an application execution unit 25 of the tablet terminal 20-2 displays on the screen of the display unit 27 a display that relates to “configuration of reconfigured network” and “permission of network reconfiguration.”

When the user gives permission to perform reconfiguration to the tablet terminal 20-2, the network C shown in FIG. 11C will be configured by the HU 10, tablet terminal 20-1, tablet terminal 20-2, and mobile communication terminal 30.

In step ST205, the application execution unit 25 of the tablet terminal 20-1 receives the network connection information about the HU 10 via near-field communications with the HU 10. The application execution unit 25 of the tablet terminal 20-1 also transmits the received network connection information about the HU 10 to the other tablet terminal 20-2, to which the permission to perform network reconfiguration has been given, via wireless LAN communications with the mobile communication terminal 30.

The application execution unit 25 of the tablet terminal 20-2 establishes a wireless LAN connection to the HU 10 by using the network connection information about the HU 10 received from the tablet terminal 20-1.

When the user refuses to give permission to perform reconfiguration to the tablet terminal 20-2, the tablet terminal 20-2 maintains its wireless LAN connection to the mobile communication terminal 30. On the other hand, the tablet terminal 20-1 reconnects to the mobile communication terminal 30 via the HU 10.

In the case above, the tablet terminal 20-2 does not receive the service provided by the HU 10, but only receives the service provided by the mobile communication terminal 30.

Next, the case of restoring the network configuration of the network C shown in FIG. 11C to those of the networks A and B shown in FIG. 11A will be explained.

In step ST112 of FIG. 8, the network configuration unit 17 of the HU 10 transmits a command to restore the network configuration of the reconfigured network to that of the original one to all the tablet terminals 20-1 and 20-2 via wireless LAN communications.

The tablet terminals 20-1 and 20-2 each perform processes of steps ST214 and ST215, not only when a condition for restoring the network configuration is detected in the tablet terminals 20-1 and 20-2 in step ST211 of FIG. 9 (“YES” in step ST211), but also when the command to restore the network configuration is received from the HU 10 (corresponding to the process of step ST213) even if such a condition is not detected in the terminals (“NO” in step ST211).

What is explained above is the case in which the number of tablet terminals 20, each of which is a slave terminal, is two. However, the number of tablet terminals may be three or more.

As explained above, the network configuration unit 17 of the HU 10 according to Embodiment 2 is configured to, in a situation in which plural tablet terminals 20 join the network provided by the mobile communication terminal 30, configure a network which the HU 10, the mobile communication terminal 30 and the plural tablet terminals 20 join, using the network connection information acquired from one of the plural tablet terminals 20. As a result, the communication system can reconfigure at a time the network which the plural tablet terminals 20 join. Therefore, the operation burden on the user can be reduced, and the inconvenience of making settings can be also reduced. Further, by connecting the plural tablet terminals 20 to the AP operation unit 12 of the HU 10, content data held by one of the plurality of tablet terminals 20 can be shared between the remaining tablet terminal 20.

While the invention has been described in its preferred embodiments, it is to be understood that combination, modification or omission of parts of embodiments described above may be made within the scope of the invention.

### INDUSTRIAL APPLICABILITY

Because when a connection request is notified from a slave terminal, the communication device according to the present invention acquires network connection information from the slave terminal and reconfigures a wireless network, the communication device is suitable for use in a vehicle-mounted device such as a head unit that provides a service for a slave terminal via a wireless network.

### REFERENCE SIGNS LIST

10 HU (communication device), 11 control unit, 12 AP operation unit, 13 STA operation unit, 14 wireless LAN management unit (wireless network manager), 15 short-range wireless communication unit (information acquirer), 16 storage, 17 network configuration unit, 18 media player, 19 input unit, 20, 20-1, 20-2 tablet terminal (slave terminal), 21 control unit, 22 STA operation unit, 23 storage, 24 short-range wireless communication unit, 25 application execution unit, 26 input unit, 27 display unit, 30 mobile communication terminal (master terminal), and A to D network.

1. A dual-mode communication device that is operable in both master mode and slave mode, the communication device comprising:
an information acquirer to acquire network connection information required to join a first wireless network provided by a master terminal from a slave terminal that joins the first wireless network, when a request for connection to a second wireless network provided by the communication device as a master is notified from the slave terminal; and
a network configurator to configure anew a third wireless network which at least the communication device, the master terminal and the slave terminal join, using the network connection information acquired by the information acquirer.

2. The communication device according to claim 1, wherein the master terminal is a mobile communication terminal, and the third wireless network is configured in such a manner that the communication device relays communications between the master terminal and the slave terminal.

3. The communication device according to claim 1, wherein the communication device is a vehicle-mounted device, and further comprises a wireless network manager to manage a frequency band or a communication timing for use in the third wireless network, thereby preventing radio wave interference.

4. The communication device according to claim 1, wherein the information acquirer receives the connection request and the network connection information from the slave terminal via short-range wireless communications.

5. The communication device according to claim 1, wherein when a plurality of slave terminals join the first wireless network provided by the master terminal, the network configurator configures the third wireless network which the communication device, the master terminal and the plurality of slave terminals join, using network connection information acquired from one of the plurality of slave terminals.

6. A communication system including a dual-mode communication device that is operable in both master mode and slave mode, a master terminal, and a slave terminal, the communication device comprising:
an information acquirer to acquire network connection information required to join a first wireless network provided by the master terminal from the slave terminal that joins the first wireless network, when a request for connection to a second wireless network provided by the communication device as a master is notified from the slave terminal; and
a network configurator to configure anew a third wireless network which at least the communication device, the master terminal and the slave terminal join, using the network connection information acquired by the information acquirer.

7. The communication system according to claim 6, wherein the slave terminal acquires an application program for reconfiguration of wireless network from an external source when the slave terminal notifies a connection request to the second wireless network to the communication device, and operates in accordance with the application program to notify the communication device of the network connection information that is used to join the first wireless network.

8. The communication system according to claim 6, the slave terminal comprising:
a storage to store the network connection information that is used to join the first wireless network,
wherein when a connection to the third wireless network is disconnected, re-joins the first network by using the network connection information stored in the storage.
